(19) United States
(12) Patent Application Publication
(10) Pub. No.: US 2026/0238014 A1
(43) Pub. Date: Aug. 13, 2026

(54) POWER ELECTRONIC ARCHITECTURE FOR HOME ENERGY MANAGEMENT WITH BIDIRECTIONAL POWER TRANSFER CAPABILITY

(71) Applicant: MAGNA INTERNATIONAL INC., Aurora (CA)

(72) Inventors: Philip KORTA, Troy, MI (US); Animesh ANIK, Windsor (CA); Ying ZUO, Windsor (CA); Caniggia VIANA, Windsor (CA); Narayan C. KAR, Windsor (CA); Johannes MARKTL, Sankt Valentin (AT); Martin WINTER, St. Valentin (AT); Harminder Singh TOOR, Windsor (CA)

(21) Appl. No.: 19/532,065

(22) Filed: Feb. 6, 2026

Related U.S. Application Data
(60) Provisional application No. 63/755,311, filed on Feb. 7, 2025.

(51) Int. Cl. H02J 3/32; B60L 53/51; B60L 53/63; B60L 53/64; B60L 53/80; H01M 10/46; H01M 50/249; H01M 50/51; H02J 3/007; H02J 3/36; H02J 3/388; H02J 7/02; H02J 101/24; H02J 105/12

(52) U.S. Cl. CPC H02J 3/322; B60L 53/51; B60L 53/80; H01M 10/46; H01M 50/249; H01M 50/51; H02J 3/007; H02J 3/36; H02J 3/388; H02J 7/02; B60L 53/63; B60L 53/64; B60L 2210/10; H01M 2220/20; H02J 2101/25; H02J 2105/12

(57) ABSTRACT

A home energy management system (HEMS) includes a first battery and a power converter. The power converter includes: a high-voltage direct current (HVDC) bus having a positive conductor and a reference conductor defining a DC voltage of at least 270V therebetween; an inverter configured to: convert alternating current (AC) power from a utility grid source to HVDC power on the HVDC bus for charging the first battery, and to convert power from the HVDC bus to AC power for supplying a home load; and a bi-directional DC-DC converter configured to transmit power between the HVDC bus and the first battery. The HEMS further includes: a HVDC plug configured to selectively connect the HVDC bus to a second battery located onboard an electrified vehicle, or the first battery is configured to be physically and electrically disconnected from the utility grid source and swapped-out with another battery of the electrified vehicle.

### CROSS REFERENCE TO RELATED APPLICATIONS

This utility patent application claims the benefit of U.S. Provisional Patent Application No. 63/755,311 filed Feb. 7, 2025, the contents of which is incorporated herein by reference in its entirety.

### FIELD

The present disclosure relates generally to a power electronics architecture and controls for home/commercial energy management system with swappable battery and/or vehicle charging/discharging capability.

### BACKGROUND

Home energy management systems (HEMS) like Tesla Powerwall, GM energy home system, etc. are emerging products that connect solar PV, battery energy storage, electric vehicle, home and the utility grid.

Additionally, BaaS (battery as a service) is an emerging service for two wheelers and new mobility vehicles. This service enables the end user to swap the used battery with lower SOC with a full charged battery for a fee. This also enables the end user to remain hands-off with respect to owning or servicing a battery.

### SUMMARY

The present disclosure provides a home energy management system (HEMS). The HEMS comprises: a first battery and a power converter. The power converter includes: a high-voltage direct current (HVDC) bus having a positive conductor and a reference conductor defining a DC voltage of at least 270V therebetween; an inverter configured to: convert alternating current (AC) power from a utility grid source to HVDC power on the HVDC bus for charging the first battery, and to convert power from the HVDC bus to AC power for supplying a home load; and a bi-directional DC-DC converter configured to transmit power between the HVDC bus and the first battery. The HEMS further includes at least one of: a HVDC plug configured to selectively connect the HVDC bus to a second battery located onboard an electrified vehicle, or the first battery is configured to be physically and electrically disconnected from the utility grid source and swapped-out with another battery of the electrified vehicle.

The present disclosure also provides a swappable battery module for an electrified vehicle. The swappable battery module comprises: a multi-module inverter (MMI) having a plurality of integrated power modules, wherein each of the integrated power modules includes one or more battery cells and a power electronics assembly physically and electrically coupled to the one or more battery cells and configured to generate AC power on a set of load terminals using DC power from the one or more battery cells connected to a DC port of the integrated power module. The swappable battery module is configured to be physically and electrically removed from the electrified vehicle and to be charged from a utility grid source while being removed from the electrified vehicle.

These and other aspects of the present disclosure are disclosed in the following detailed description of the embodiments, the appended claims, and the accompanying figures

### BRIEF DESCRIPTION OF THE DRAWINGS

Further details, features and advantages of designs of the invention result from the following description of embodiment examples in reference to the associated drawings.

FIG. 1 shows a schematic diagram of a first home energy management system (HEMS), in accordance with an aspect of the present disclosure;

FIG. 2 shows a schematic diagram of a second HEMS, in accordance with an aspect of the present disclosure;

FIG. 3 shows a schematic diagram of a third HEMS, in accordance with an aspect of the present disclosure;

FIG. 4 shows a schematic diagram of a fourth HEMS, in accordance with an aspect of the present disclosure;

FIG. 5 shows a schematic diagram of a fifth HEMS, in accordance with an aspect of the present disclosure;

FIG. 6 shows a schematic diagram of a sixth HEMS, in accordance with an aspect of the present disclosure;

FIG. 7 shows a schematic diagram of a seventh HEMS, including a modular multi-level inverter (MMI), in accordance with an aspect of the present disclosure;

FIG. 8 shows a schematic diagram of an MMI system, in accordance with an aspect of the present disclosure;

FIG. 9 shows a schematic block diagram illustrating an MMI with a centralized control system, in accordance with the present disclosure; and

FIG. 10 shows the MMI system of FIG. 8 with arrows indicating current flow therein while DC charging, in accordance with an aspect of the present disclosure.

### DETAILED DESCRIPTION

Referring to the drawings, the present invention will be described in detail in view of following embodiments.

The present disclosure provides various embodiments of home energy management systems (HEMS) with BaaS (battery as a service) features for swappable batteries.

The present disclosure provides a swappable battery system for electrified vehicles (EVs) such as battery electric vehicles, plugin hybrid electric vehicles and hybrid vehicles. These EVs could have battery pack ratings between 1 kWh and 12 kWh which is the similar rating of energy storage batteries in HEMS. kWh is not a limiting factor. This means swappable batteries from EVs could be recharged using the HEMS system at home/commercial locations as the HEMS system proposed in this patent has a tiltable container to house swappable batteries. The HEMS could hold one or several battery packs. These battery packs can be operated while switched in parallel, in series or stand-alone.

For example, an EV may return home mid-day with a state of charge (SOC) below 30%. The discharged batteries from this EV could be instantly swapped with the batteries present in the HEMS system. This would allow the vehicle to get back on the road with fully charged batteries in a very short time. The batteries present in the HEMS system would have been charged using renewable energy during the day when the electricity tariff is at its peak rate. Moreover, the electronics within HEMS used for serving loads at home may be same as the electronics used to charge the battery. Hence, separate electronics may not be necessary for battery charging and serving home loads.

In another case, the HEMS system could charge the batteries in the EV with swappable or non-swappable batteries by plugging the HEMS box to the EV via utility grid supply that is usually billed at off-peak tariff (for example 8 cents/kWh) in the evening.

Swappable batteries for mild hybrid or full hybrid vehicles with less than 2 kWh make sense, as these vehicles do not have a plug-in option. Currently batteries in such vehicles are being charged by combustion engine+generator in the vehicle and regenerative braking. Using swappable batteries in these vehicles will enable more mileage/range in addition to other advantages of the battery swapping services to the end user.

The HEMS system could be sold and operated by a same company that owns the batteries as well.

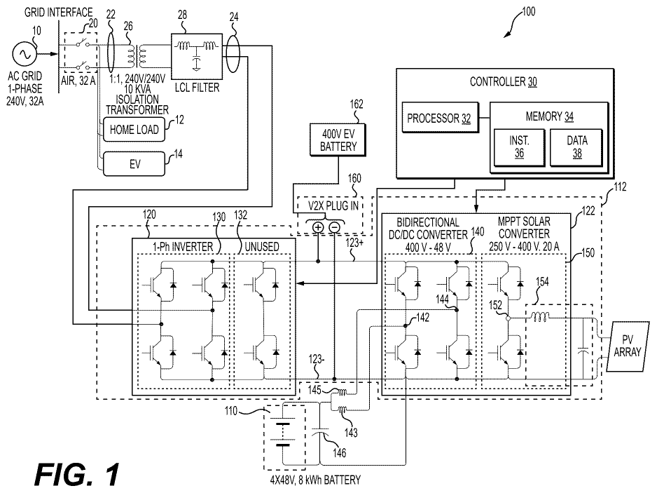

FIG. 1 shows a schematic diagram of a first home energy management system (HEMS) 100, in accordance with an aspect of the present disclosure. The first HEMS 100 may be installed in a home or other fixed location and is configured to receive alternating current (AC) power from a utility grid source 10 and to store energy in a first battery 110, for providing power to one or more AC loads 12, 14 in case the utility grid source 10 becomes unavailable, such as during a power outage. The first battery 110 may also be called a home battery and may be attached to a fixed location. The AC loads 12, 14 may include home loads 12, such as lighting, appliances, and/or other devices that may be connected to an electrical distribution panel in a home. Alternatively or additionally, the AC loads 12, 14 may include an electric vehicle supply equipment (EVSE) device 14 for charging an electrified vehicle that uses electrical energy for propulsion.

The first HEMS 100 includes an anti-islanding relay (AIR) 20 that is configured to regulate current flow between the utility grid source 10 and a first internal AC bus 22 that is connected to the AC loads 12, 14. The AIR 20 may include a circuit breaker that switches to an open circuit condition and prevents current therethrough in response to the current exceeding a predetermined amount, such as 32 Amps. The AIR 20 may also function to disconnect the first internal AC bus 22 from the utility grid source 10 when a blackout occurs and to maintain the first internal AC bus 22 disconnected to prevent backfeeding power from the first internal AC bus 22 to the utility grid source 10. In some embodiments, the AIR 20 may include a smart meter to measure and transmit information regarding power transferred from and/or to the utility grid source 10.

The first HEMS 100 also includes a second internal AC bus 24 upon which generated AC power is transmitted. An isolation transformer 26 and a first inductor-capacitor-inductor (LCL) filter 28 are connected between the second internal AC bus 24 and the first internal AC bus 22 for transmitting power therebetween, while providing electrical isolation and improving quality of the AC power on the first internal AC bus 22. For example, the isolation transformer 26 and the first LCL filter 28 may reduce transient currents and/or improve power factor.

The first HEMS 100 also includes a first power converter 112. The first power converter 112 includes a first 3-phase power conversion device 120, a second 3-phase power conversion device 122, and a high-voltage direct current (HVDC) bus 123+, 123−, having a positive conductor 123+and a reference conductor 123− defining a DC voltage of at least 270V therebetween. Each of the 3-phase power conversion devices 120, 122 may be commercially-available inverter devices having three legs. Each of the three legs has an identical configuration with two switching transistors connected in series between the positive conductor 123+ and the reference conductor 123− of the HVDC bus 123+, 123−.

Two legs of the first 3-phase power conversion device 120 may be connected to the second internal AC bus 24 and operated in combination to function as a single-phase inverter 130. The single-phase inverter 130 may be operated to convert AC power from the utility grid source 10 to HVDC power on the HVDC bus 123+, 123− for charging the first battery 110. The single-phase inverter 130 may also be operated to convert power from the HVDC bus to AC power on the second internal AC bus 24 for supplying the AC loads 12, 14 when the AIR 20 is an open-circuit condition, such as during and/or after the utility grid source 10 having a blackout condition. A third leg 132 of the first 3-phase power conversion device 120 may be unused in the first power converter 112.

Two legs of the second 3-phase power conversion device 122 are operated as a bi-directional DC-DC converter 140 to transmit power between the HVDC bus 123+, 123− and the first battery 110. The bi-directional DC-DC converter 140 includes a first leg having two switching transistors connected in series between the positive conductor 123+ and the reference conductor 123− of the HVDC bus 123+, 123− and defining a first middle node 142 therebetween. The bi-directional DC-DC converter 140 also includes a second leg having two switching transistors connected in series between the positive conductor 123+ and the reference conductor 123− of the HVDC bus 123+, 123− and defining a second middle node 144 therebetween. The first middle node 142 is connected to a positive battery terminal of the first battery 110 via a first inductor 143, and the second middle node 144 is connected to the positive battery terminal of the first battery 110 via a second inductor 145. The negative terminal of the first battery 110 is connected to the reference conductor 123− of the HVDC bus 123+, 123−, and a filter capacitor 146 is connected across the terminals of the first battery 110. A third leg of the second 3-phase power conversion device 122 may be operated as a first Maximum Power Point Tracking (MPPT) solar converter 150 for supplying power to the HVDC bus 123+, 123− from a photovoltaic (PV) array 16 connected thereto. The first MPPT solar converter 150 has two switching transistors connected in series between the positive conductor 123+ and the reference conductor 123− of the HVDC bus 123+, 123− and defines a third middle node 152 therebetween. The PV array 16 is connected to the reference conductor 123− of the HVDC bus 123+, 123−, and to the third middle node 152 of the first MPPT solar converter 150 via an inductor-capacitor (LC) filter 154.

The first HEMS 100 also includes a HVDC plug 160, which may also be called a V2X Plug in, and which is configured to selectively connect the HVDC bus 123+, 123− to a second battery 162 located onboard an electrified vehicle. The second battery 162 may have a nominal or charging voltage, such as 400VDC that matches a DC voltage of the HVDC bus 123+, 123−. Alternatively or additionally, the first battery 110 may be configured to be physically and electrically disconnected from the utility grid source 10 and swapped-out with another battery of the electrified vehicle.

The first HEMS 100 also includes a controller 30, which may also be called an electronic control unit (ECU), in communication with each of the 3-phase power conversion devices 120, 122 to control operation of the single-phase inverter 130, the bi-directional DC-DC converter 140, and the first MPPT solar converter 150, and/or to monitor parameters measured by sensors associated with the 3-phase power conversion devices 120, 122. The controller 30 includes a processor 32 coupled to a storage memory 34. The storage memory 34 stores instructions, such as program code for execution by the processor 32, in an instruction storage 36. The storage memory 34 also includes data storage 38 for holding data to be used by the processor 32. The data storage 38 may record, for example, values of the measured parameters and/or the outcome of functions calculated by the processor 32.

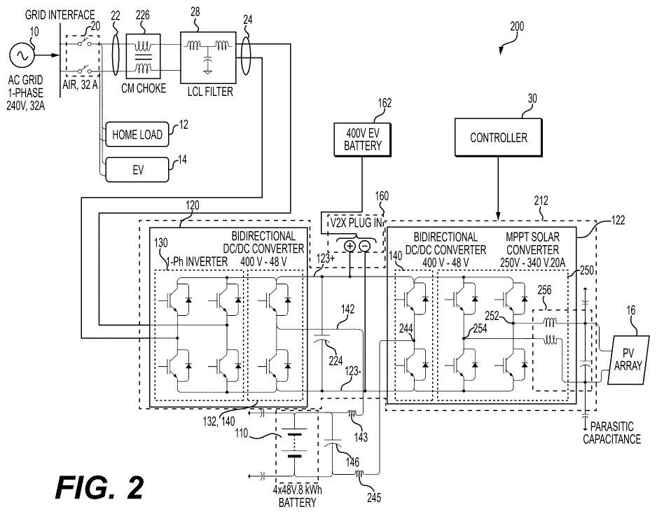

FIG. 2 shows a schematic diagram of a second HEMS 200. The second HEMS 200 may be similar or identical to the first HEMS 100, except for a few differences described herein. The second HEMS 200 includes a common-mode choke 226 in place of the isolation transformer 26 used in the first HEMS 100. The common-mode choke 226 may have a high inductance that may function to prevent transient currents from going to the utility grid source 10, thereby reducing risk of causing a grid fault.

The second HEMS 200 also includes a second power converter 212, which is similar to the first power converter 112 of the first HEMS 100. The second HEMS 200 also includes the bi-directional DC-DC converter 140 being split between the 3-phase power conversion devices 120, 122. The third leg 132 of the first 3-phase power conversion device 120, and only one leg of the second 3-phase power conversion device 122 form the bi-directional DC-DC converter 140. The one leg of the second 3-phase power conversion device 122 forming the bi-directional DC-DC converter 140 defines a fourth middle node 244 between the two switching transistors. Unlike the first HEMS 100, the second HEMS 200 includes the negative terminal of the first battery 110 not connected to the reference conductor 123− of the HVDC bus 123+, 123−. Instead, the negative terminal of the first battery 110 in the second HEMS 200 is connected to the fourth middle node 244 via inductor 245.

The second power converter 212 also includes a second MPPT solar converter 250 in place of the first MPPT solar converter 150. The second MPPT solar converter 250 uses two legs of the second 3-phase power conversion device 122, each having two switching transistors connected in series between the positive conductor 123+ and the reference conductor 123− of the HVDC bus 123+, 123− and each defining a corresponding middle node 252, 254 therebetween. The PV array 16 is connected to the two middle nodes 252, 254 of the second MPPT solar converter 250 via a second LCL filter 256.

In some embodiments, the single-phase inverter 130 and/or the bi-directional DC-DC converter 140 may be operated using a bi-polar pulse width modulation (PWM) technique. Using a bi-polar PWM technique may minimize common-mode voltage.

Current from power sources, such as the utility grid source 10, home battery 110, and/or solar panels in a PV array 16 may be equally distributed between the two 3-phase power conversion devices 120, 122 to reduce the current loads, which may enable use of reduced inductor size when compared to alternative designs.

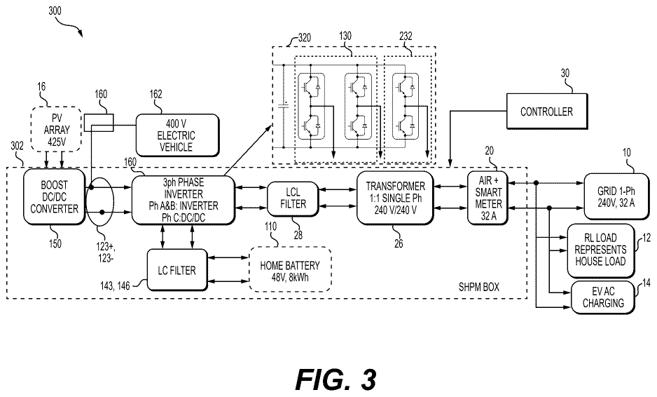

FIG. 3 shows a schematic diagram of a third HEMS 300 of the present disclosure, and which uses one automotive 3-phase inverter device 320 for both DC-AC and DC-DC functions. The third HEMS 300 may be similar or identical to the first HEMS 100, except for a few differences described herein. The third HEMS 300 includes a first smart home power management (SHPM) box 302 that combines components in an integrated package. The third HEMS 300 may utilize a 3^{rd} leg of the 3-phase inverter device 320 to control charging/discharging of the home battery 110. This arrangement of the third HEMS 300 may provide a significant reduction in cost and size when compared to alternative designs.

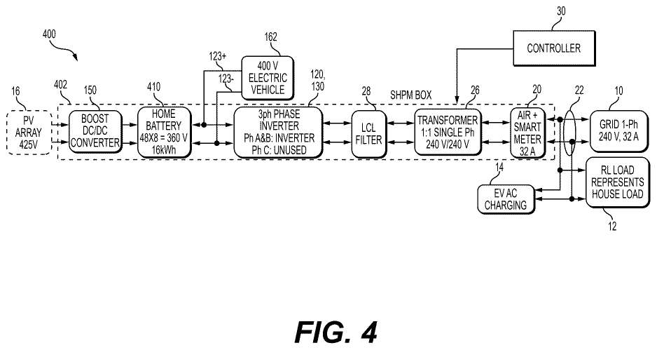

FIG. 4 shows a schematic diagram of a fourth HEMS 400 of the present disclosure. The fourth HEMS 400 may provide a significant reduction in cost and size when compared to alternative designs. The fourth HEMS 400 may be similar or identical to the first HEMS 100, except for a few differences described herein. The fourth HEMS 400 includes a second smart home power management (SHPM) box 402 that combines components in an integrated package. The fourth HEMS 400 includes an HV home battery 410 in place of the first battery 110. The HV home battery 410 is connected directly to the HVDC bus 123+, 123−. Thus, the fourth HEMS 400 does not require a bi-directional DC/DC converter for charging the HV home battery 410.

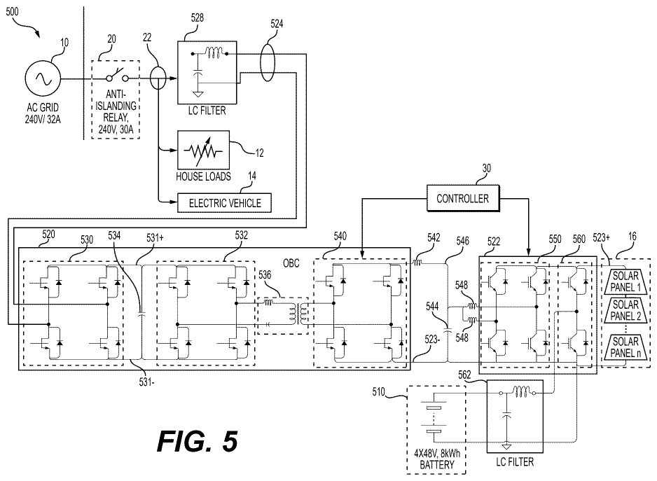

FIG. 5 shows a schematic diagram of a fifth HEMS 500 of the present disclosure. The fifth HEMS 500 utilizes an on-board charger (OBC) 520 of an electrified vehicle (EV) for power conversion. The fifth HEMS 500 also includes a 3-phase power conversion device 522. The controller 30 may be configured to control operation of each of the OBC 520 and the 3-phase power conversion device 522. The fifth HEMS 500 also includes a first battery 510, which may be similar or identical to the first battery 110 of the first HEMS 100.

The fifth HEMS 500 also includes a second internal AC bus 524 upon which generated AC power is transmitted. A fifth inductor-capacitor (LC) filter 528 is connected between the second internal AC bus 524 and the first internal AC bus 22 for transmitting power therebetween, while improving quality of the AC power on the first internal AC bus 22. For example, the fifth LC filter 528 may reduce transient currents.

The OBC 520 of the fifth HEMS 500 includes a first power converter 530 with an H-Bridge configuration of four switching transistors configured to transmit power between the second internal AC bus 524 and a first internal DC bus 531+, 531−. A capacitor 534 is connected across the first internal DC bus 531+, 531−. The OBC 520 of the fifth HEMS 500 also includes a second power converter 532 with an H-Bridge configuration of four switching transistors configured to transmit power between the first internal DC bus 531+, 531− and to an inductor-inductor-capacitor (LLC) circuit 536. The inductor-inductor-capacitor (LLC) circuit 536 includes an inductor in series with a first winding of a transformer and with a capacitor. The OBC 520 of the fifth HEMS 500 also includes a third power converter 540 with an H-Bridge configuration of four switching transistors configured to transmit power between a second winding of the transformer in the LLC circuit 536 and an LC circuit 542, 544. The LC circuit 542, 544 includes an inductor 542 in series with a capacitor 544 and defining an intermediate node 546 therebetween. The capacitor is connected to the third power converter 540 at a reference conductor 523−.

The fifth HEMS 500 also includes a high-voltage direct current (HVDC) bus 523+, 523−, having a positive conductor 523+ and including the reference conductor 523−. The HVDC bus 523+, 523− may define DC voltage of at least 270V therebetween.

The 3-phase power conversion device 522 of the fifth HEMS 500 may be a commercially-available inverter device having three legs. Each of the three legs has an identical configuration with two switching transistors connected in series between the positive conductor 523+ and the reference conductor 523− of the HVDC bus 523+, 523−.

Two legs of the 3-phase power conversion device 522 may form a fourth power converter 550 for transmitting power to and from the first battery 510. Each of the two legs of the 3-phase power conversion device 522 forming the fourth power converter 550 includes two switching transistors connected in series between the positive conductor 523+ and the reference conductor 523− of the HVDC bus 523+, 523− to define a middle node therebetween. The middle nodes of each of the two legs of the 3-phase power conversion device 522 forming the fourth power converter 550 are each connected to the intermediate node 546 via corresponding inductors 548.

A third leg 132 of the 3-phase power conversion device 522 forms a fifth power converter 560 configured to transmit power between the HVDC bus 523+, 523− and the first battery 510. An LC filter 562 is connected between the fifth power converter 560 and the first battery 510. The PV array 16 is connected directly to the HVDC bus 523+, 523−.

The 3-phase power conversion device 522 of the fifth HEMS 500 can be operated as a solar MPPT converter and as a bi-directional DC/DC converter for charging the first battery 510. The OBC 520 can be controlled for DC to AC conversion and to perform power factor correction.

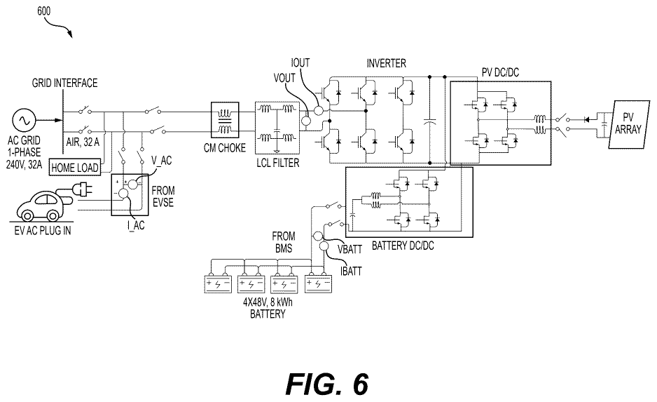

FIG. 6 shows a schematic diagram of a sixth HEMS 600 of the present disclosure. The sixth HEMS 600 includes one automotive inverter and two (2) DC-DC power converters.

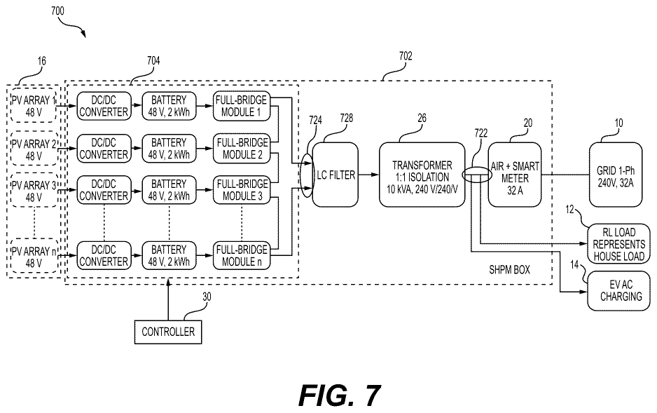

FIG. 7 shows a schematic diagram of a seventh HEMS 700 of the present disclosure. The seventh HEMS 700 includes a SHPM box 702 having a modular multi-level inverter (MMI) 704 for providing power to one or more AC loads 12, 14 and receiving power from the utility grid source 10. Optionally, and as shown in FIG. 7, the SHPM box 702 may also receive power from a PV array 16. The SHPM box 702 of the seventh HEMS 700 includes a third internal AC bus 722 connected to one or more AC loads 12, 14, and a fourth internal AC bus 724 upon which generated AC power is transmitted to/from the MMI 704. An inductor-capacitor (LC) filter 728 and an isolation transformer 26 are connected between the fourth internal AC bus 724 and the third internal AC bus 722 for transmitting power therebetween, while providing electrical isolation and improving quality of the AC power on the third internal AC bus 722. For example, the isolation transformer 26 and the LC filter 728 may reduce transient currents and/or improve power factor.

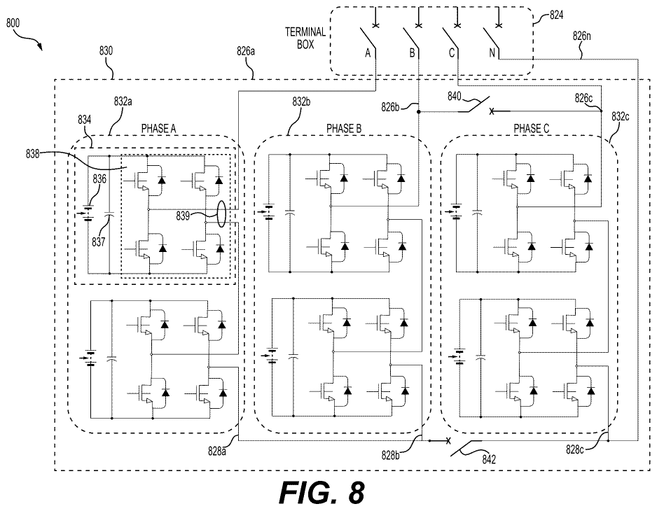

FIG. 8 shows a schematic diagram of an MMI system 800 of the present disclosure. The MMI system 800 may be used to implement the MMI 704 in the seventh HEMS 700. The MMI system 800 includes a terminal box 824 connected to an MMI assembly 830.

The MMI assembly 830 may be configured to supply one or more electric motors in an EV with 3-phase power via the terminal box 824. However, the MMI assembly 830 may be operated to supply and receive single-phase AC power, making it also suitable for use in the seventh HEMS 700.

The MMI assembly 830 shown in FIG. 8 includes three phase groups 832a, 832b, 832c, each generating a single-phase of AC power for supply to an external load via the terminal box 824, which may also be called an AC bus connector. Each of the phase groups 832a, 832b, 832c includes several integrated power modules 834 in a series configuration. Each of the integrated power modules 834 may have a similar or identical configuration. The MMI assembly 830 shown in FIG. 8 includes two integrated power modules 834 in each of the phase groups 832a, 832b, 832c. However, the MMI assembly 830 may have a larger number of the integrated power modules 834 in each of the phase groups 832a, 832b, 832c.

In some embodiments, and as shown FIG. 8, each of the integrated power modules 834 may be configured as primary modules, including a battery module 836. The battery module 836 may have a 90-V nominal voltage. However, the battery module 836 may have a different voltage, such as 12V, 24V, or 48V. Additionally or alternatively, some of the integrated power modules 834 may be configured as secondary modules, which do not contain a battery, but instead are connected to an external battery.

Each of the integrated power modules 834 includes an input capacitor 837, and a power electronics assembly 838. The power electronics assembly 838 may be physically and electrically coupled to the battery module 836 and configured to receive direct current (DC) power therefrom and to generate alternating current (AC) power on a set of load terminals 839, using the DC power from the battery module 836. In some embodiments, each of the power electronics assemblies 838 may include four switching transistors in an H-bridge configuration.

The load terminals 839 of the integrated power modules 834 within each of the phase groups 832a, 832b, 832c are connected together in the series configuration to generate AC output power on a corresponding AC output conductor 826a, 826b, 826c. Each of the phase groups 832a, 832b, 832c also defines a corresponding lower node 828a, 828b, 828c, opposite of the AC output conductors 826a, 826b, 826c. In other words, load terminals 839 of the integrated power modules 834 within each of the phase groups 832a, 832b, 832c are connected in the series configuration between a lower node 828a, 828b, 828c and a corresponding one of the AC output conductors 826a, 826b, 826c. Thus, the phase groups 832a, 832b, 832c may provide the 3-phase AC power. The series connection of the integrated power modules 834 enables each of the phase groups 832a, 832b, 832c to provide the AC output power with power and/or voltage ratings many times greater than can be supplied by any one of the integrated power modules 834, alone.

The MMI assembly 830 shown in FIG. 8 also includes a module neutral conductor 826n, which may serve as a reference conductor and/or as a current carrying conductor for a single-phase load connected to one of the AC output conductors 826a, 826b, 826c.

The MMI assembly 830 also includes a first set of contacts 840 configured to selectively connect the b-phase AC output conductor 826b with the c-phase AC output conductor 826c. The c-phase lower node 828c is connected to the module neutral conductor 826n. The a-phase lower node 828a and the b-phase lower node 828b are connected together. The MMI assembly 830 also includes a second set of contacts 842 configured to selectively connect the b-phase lower node 828b to the module neutral conductor 826n. The first set of contacts 840 and the second set of contacts 842 may be selectively commanded by the controller 30 to convert the three phase groups 132a, 132b, 132c to a series connection, thereby configuring the three phase groups 132a, 132b, 132c for single-phase operation.

In a 3-phase configuration, the first set of contacts 840 is in an open-circuit condition, and the second set of contacts 842 is in a closed-circuit condition, thereby causing the lower node 828a, 828b, 828c of the phase groups 832a, 832b, 832c to all be connected together. In a single-phase configuration, the first set of contacts 840 is in a closed-circuit condition, and the second set of contacts 842 is in an open-circuit condition.

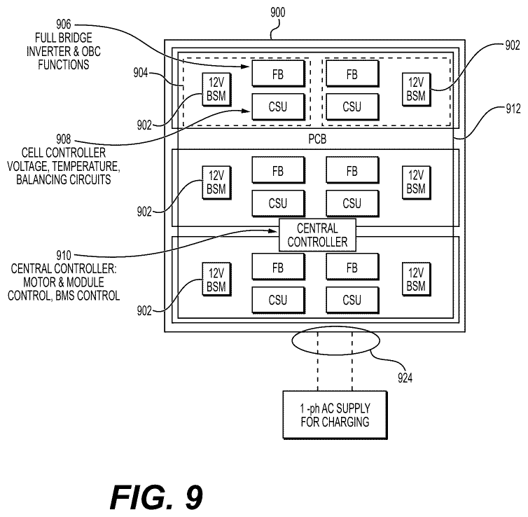

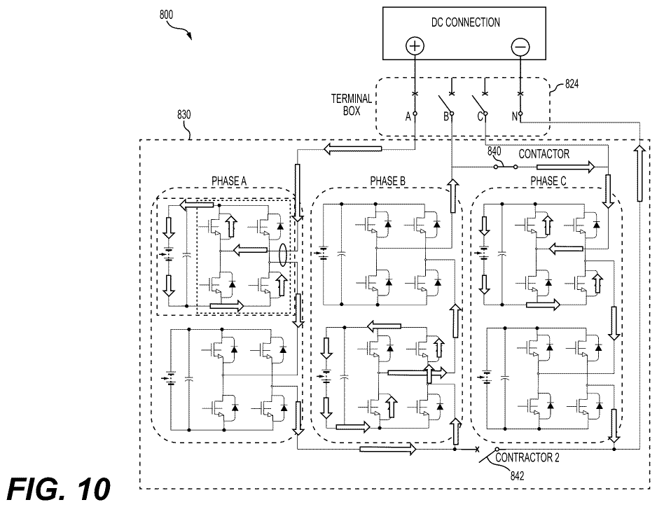

FIG. 9 shows a schematic block diagram illustrating an MMI 900 with a centralized control system. In this configuration, the MMI 900 includes an onboard central controller 910. The MMI 900 of FIG. 10 includes several MMI modules 902, each including a battery 904, a full-bridge power converter 906, and a cell controller 908. In some embodiments, and as shown in FIG. 9, two or more of the MMI modules 902 may be combined onto a single printed circuit board (PCB) 912. The MMI 900 defines a single-phase AC bus 924 for transferring AC power to and from external circuitry.

FIG. 10 shows the MMI system 800 of FIG. 8 with the contacts 840, 842 arranged for the single-phase configuration, and with arrows indicating current flow therein while DC charging, in accordance with an aspect of the present disclosure. The same contacts 840, 842 used for DC charging the MMI system may also be used to operate the MMI assembly 830 for single-phase AC operation in the seventh HEMS 700.

According to a further aspect of the present disclosure, the home battery 110 may be configured to be physically and electrically disconnected from the power converter and swapped-out with another battery of an EV. Such swappable home batteries 110 may have one of several different architectures, such as:
Batteries with an onboard battery management system (BMS);
MMI system with BMS, onboard charging (OBC) and inverter functions;
Batteries with BMS and OBC functions; and/or
Batteries with reverse compatibility.

Batteries with onboard BMS—These may include conventional swappable batteries that can also be charged using the HEMS system. For instance, today, there are swappable battery stations in public locations where these batteries have to be recharged multiple times. Installation of the HEMS system in these locations can charge the swappable batteries and provide a mix of renewable and grid power to that location. As result, the cost of the charging/swapping could be reduced. This is also an incentive for consumers to buy and use the HEMS system as it has multiple use cases.

Batteries with BMS, OBC and Inverter functions—All the electronics needed for the HEMS system, conventional battery charging station for swappable battery and propelling the vehicle will remain on the battery module.

Batteries with BMS, and OBC—The battery may include BMS and OBC functionality, but without any integrated inverter circuit because the motor and inverter already exist on the vehicle, then the battery will only have OBC and BMS functions. The MMI 900 shown in FIG. 9 shows such a configuration.

Batteries with reverse compatibility—Reverse compatibility may refer to a MMI configured for single-phase AC charging and/or discharging and/or to provide a 3-phase AC supply. The MMI assembly 830 is an example of such a battery with reverse compatibility.

For the swappable battery pack to be backwards compatible, a DC connection may be required to support conventional eDrives that have an inverter controlling and providing the 3-phase excitation to the machine. To create a DC bus, the 3 phases are put in series to increase voltage and create a DC connection. This architecture requires 2 extra contactors (or semiconductors) and a terminal connection point of the MMI neutral. Contactor 1 is closed and contactor 2 is open to establish a series connection of the 3 phases by connecting phase A and the neutral point. This aspect is illustrated in FIG. 10.

This configuration enables backwards compatibility to conventional systems. If the series DC connection requirement results in a higher voltage than is needed by the external system, select modules can be bypassed to reduce the DC voltage to the appropriate level. For example, if an MMI system that has two modules per phase at 12V and needs to support a conventional 48V system, the DC series connection would result in a 12*6=72V bus. However, by bypassing any of the two of the 6 modules in the series string using the full-bridge modules, a 48V output is achieved. In addition, the modules can be selectively bypassed during operation to achieve module balancing (in terms of SoC, thermal, and SoH) by alternating utilization.

To use an MMI-based battery system for an SHPM system, the battery may be configured to provide a single-phase connection between phase A and the neutral, N. If the series connection of the modules is larger than the grid voltage, the full bridges can be controlled to provide a single-phase voltage that can control the power flow between the grid and battery.

Alternatively or additionally, the backwards compatible configuration described above can be used to provide a DC connection point from the series connection of the modules between phase A and the neutral, N. The effective battery voltage can be controlled by activating or bypassing modules in the series string using the full-bridge modules. In addition, the modules can be selectively bypassed during operation to achieve module balancing, in terms of state of charge (SoC), thermal, and/or state of health (SoH) by alternating battery utilization. The DC battery connection may be either directly connected to the HV bus of the system or if the battery voltage is lower than the requirement, a boost converter may be used to boost the voltage to the appropriate level of the HV bus and control power flow between the battery and other components in the system.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A home energy management system (HEMS), comprising:
a first battery; and
a power converter including:
a high-voltage direct current (HVDC) bus having a positive conductor and a reference conductor defining a DC voltage of at least 270V therebetween;
an inverter configured to: convert alternating current (AC) power from a utility grid source to HVDC power on the HVDC bus for charging the first battery, and to convert power from the HVDC bus to AC power for supplying a home load; and
a bi-directional DC-DC converter configured to transmit power between the HVDC bus and the first battery, and
wherein the HEMS further includes at least one of: a HVDC plug configured to selectively connect the HVDC bus to a second battery located onboard an electrified vehicle, or the first battery is configured to be physically and electrically disconnected from the utility grid source and swapped-out with another battery of the electrified vehicle.

2. The HEMS of claim 1, wherein the HEMS includes the HVDC plug configured to selectively connect the HVDC bus to the second battery located onboard the electrified vehicle.

3. The HEMS of claim 1, wherein the HEMS includes the first battery configured to be physically and electrically disconnected from the power converter and swapped-out with another battery of the electrified vehicle.

4. The HEMS of claim 1, wherein the HEMS further includes a second DC-DC converter configured to convert DC power from a photovoltaic (PV) array using a maximum power point tracking (MPPT) control technique and to supply power to the HVDC bus.

5. The HEMS of claim 1, further including an isolation filter and an inductor-capacitor-inductor (LCL) filter each connected between the inverter and the utility grid source.

6. The HEMS of claim 1, further including a common-mode (CM) choke and an inductor-capacitor-inductor (LCL) filter each connected between the inverter and the utility grid source.

7. The HEMS of claim 1, wherein the first battery includes a positive battery terminal and a negative battery terminal,
wherein the bi-directional DC-DC converter includes a first leg having two switching transistors connected in series between the positive conductor and the reference conductor of the HVDC bus and defining a first middle node therebetween, and a second leg having two switching transistors connected in series between the positive conductor and the reference conductor of the HVDC bus and defining a second middle node therebetween,
wherein the first middle node is connected to the positive battery terminal of the first battery via a first inductor,
wherein the second middle node is connected to the positive battery terminal of the first battery via a second inductor, and
wherein the negative battery terminal of the first battery is connected directly to the reference conductor of the HVDC bus.

8. The HEMS of claim 1, wherein the first battery includes a positive battery terminal and a negative battery terminal,
wherein the bi-directional DC-DC converter includes a first leg having two switching transistors connected in series between the positive conductor and the reference conductor of the HVDC bus and defining a first middle node therebetween, and a second leg having two switching transistors connected in series between the positive conductor and the reference conductor of the HVDC bus and defining a second middle node therebetween,
wherein the first middle node is connected to the positive battery terminal of the first battery via a first inductor, and
wherein the second middle node is connected to the negative battery terminal of the first battery via a second inductor.

9. The HEMS of claim 1, wherein the power converter includes a 3-phase power conversion device having three legs, wherein each of the three legs has an identical configuration with two switching transistors connected in series between the positive conductor and the reference conductor of the HVDC bus,
wherein two legs of the three legs form the inverter, and
wherein a remaining leg of the three legs forms at least a portion of the bi-directional DC-DC converter.

10. The HEMS of claim 1, wherein the home load is connected to an internal AC bus, and wherein the HEMS further includes an anti-islanding relay (AIR) configured to selectively disconnect the internal AC bus from the utility grid source.

11. The HEMS of claim 1, wherein the home load is connected to an internal AC bus, and wherein the HEMS further includes an electric vehicle supply equipment (EVSE) device connected to the internal AC bus.

12. The HEMS of claim 1, further including a multi-module inverter (MMI) having a plurality of integrated power modules, wherein each of the integrated power modules includes one or more battery cells and a power electronics assembly physically and electrically coupled to the one or more battery cells and configured to generate AC power on a set of load terminals using DC power from the one or more battery cells connected to a DC port of the integrated power module,
wherein the first battery includes the one or more battery cells of the plurality of integrated power modules, and
wherein the inverter includes the power electronics assemblies of the plurality of integrated power modules.

13. The HEMS of claim 12, wherein the plurality of integrated power modules are split between a plurality of phase groups, with each of the phase groups including a corresponding subset of the plurality of integrated power modules, with the sets of load terminals of the corresponding subset of the plurality of integrated power modules connected in a series arrangement between a lower node and an AC output conductor, and
wherein the MMI further includes a plurality of switches configured to selectively connect the plurality of phase groups in a series configuration.

14. The HEMS of claim 13, wherein the plurality of switches includes a first switch configured to selectively conduct current between the AC output conductors of two phase groups of the plurality of phase groups.

15. A swappable battery module for an electrified vehicle, comprising:
a multi-module inverter (MMI) having a plurality of integrated power modules, wherein each of the integrated power modules includes one or more battery cells and a power electronics assembly physically and electrically coupled to the one or more battery cells and configured to generate AC power on a set of load terminals using DC power from the one or more battery cells connected to a DC port of the integrated power module, and
wherein the swappable battery module is configured to be physically and electrically removed from the electrified vehicle and to be charged from a utility grid source while being removed from the electrified vehicle.

16. The swappable battery module of claim 15, wherein the plurality of integrated power modules are split between a plurality of phase groups, with each of the phase groups including a corresponding subset of the plurality of integrated power modules, with the sets of load terminals of the corresponding subset of the plurality of integrated power modules connected in a series arrangement between a lower node and an AC output conductor, and
wherein the swappable battery module further includes a plurality of switches configured to selectively connect the plurality of phase groups in a series configuration.

17. The swappable battery module of claim 16, wherein the plurality of switches includes a first switch configured to selectively conduct current between the AC output conductors of two phase groups of the plurality of phase groups.

18. The swappable battery module of claim 16, wherein the plurality of switches includes a second switch configured to selectively conduct current between the lower nodes of two phase groups of the plurality of phase groups.
